(19) United States
(12) Patent Application Publication
(10) Pub. No.: US 2013/0214676 A1
(43) Pub. Date: Aug. 22, 2013

(54) SOLID-STATE LAMPS WITH IMPROVED EMISSION EFFICIENCY AND PHOTOLUMINESCENCE WAVELENGTH CONVERSION COMPONENTS THEREFOR

(71) Applicant: Intematix Corporation, (US)

(72) Inventors: Yi-Qun Li, Danville, CA (US); Haitao Yang, San Jose, CA (US); Xianglong Yuan, Fremont, CA (US); Charles Edwards, Pleasanton, CA (US)

(73) Assignee: Intematix Corporation, Fremont, CA (US)

(21) Appl. No.: 13/769,210

(22) Filed: Feb. 15, 2013

Related U.S. Application Data
(60) Provisional application No. 61/600,573, filed on Feb. 17, 2012.
(60) Provisional application No. 61/657,702, filed on Jun. 8, 2012.
(60) Provisional application No. 61/666,695, filed on Jun. 29, 2012.

(51) Int. Cl. H05B 33/12

(52) U.S. Cl. CPC H05B 33/12
USPC 313/512; 428/34.1

(57) ABSTRACT

A solid-state lamp comprising: an array of solid-state excitation sources and a photoluminescence wavelength conversion component comprising a layer of photoluminescence material and a coupling optic. The layer of photoluminescence material is remote to the excitation sources and the coupling optic is disposed between the excitation sources and the layer of photoluminescence material. The ratio of the photoluminescence material surface area of the layer of the photoluminescence material to the excitation source surface area for the array of solid-state excitation sources is at least 3 to 1.

### CROSS-REFERENCES TO RELATED APPLICATIONS

This application claims the benefit of U.S. Provisional Application No. 61/600,573, filed Feb. 17, 2012; U.S. Provisional Application No. 61/657,702, filed Jun. 8, 2012; and U.S. Provisional Application No. 61/666,695, filed Jun. 29, 2012 the content of each of which is hereby incorporated by reference in its entirety.

### BACKGROUND OF THE INVENTION

1. Field of the Invention

Embodiments of the invention relate to solid-state lamps with improved emission efficiency and photoluminescence wavelength conversion components for such lamps. In particular, although not exclusively, embodiments concern solid-state lamps with an improved radial emission characteristic. Embodiments of the invention further concern the design and manufacture of photoluminescence wavelength conversion components.

2. Description of the Related Art

White light generating LEDs, “white LEDs”, are a relatively recent innovation and offer the potential for a whole new generation of energy efficient lighting systems to come into existence. It is predicted that white LEDs could replace filament (incandescent), fluorescent and compact fluorescent light sources due to their long operating lifetimes, potentially many 100,000 of hours, and their high efficiency in terms of low power consumption. It was not until LEDs emitting in the blue/ultraviolet part of the electromagnetic spectrum were developed that it became practical to develop white light sources based on LEDs. As taught, for example in U.S. Pat. No. 5,998,925, white LEDs include one or more phosphor materials, that is photo-luminescent materials, which absorb a portion of the radiation emitted by the LED and re-emit radiation of a different color (wavelength). Typically, the LED chip or die generates blue light and the phosphor(s) absorbs a percentage of the blue light and re-emits yellow light or a combination of green and red light, green and yellow light or yellow and red light. The portion of the blue light generated by the LED that is not absorbed by the phosphor is combined with the light emitted by the phosphor to provide light which appears to the human eye as being nearly white in color.

To date high brightness white LEDs have been used to replace conventional incandescent light bulbs, halogen reflector lamps and fluorescent lamps. Most lighting devices utilizing LEDs comprise arrangements in which a plurality of LEDs replaces the conventional light source component.

Whilst LED-based lamps provide a significant improvement in efficiency compared with conventional incandescent lamps, LED-based lamps still generate a significant amount of heat that needs dissipating and are consequently heat sensitive. The external temperature of an LED is frequently maintained at less than 85° C. In comparison the operating temperature of conventional incandescent lamps is typically hundreds of degrees centigrade. Since it is desirable for LED-based lamps to be able to be retrofitted into the location of incandescent lamps good thermal management of LED-based lamps is essential. This heat sensitivity causes LED lamp designs to require bulky thermal management structures to handle the amount of heat produced by the LED lamp. In fact, the amount of thermal management structures that is typically required is so large as to proportionally dominate the volume of a conventional LED lamp. This effectively prevents many LED lamps from being able to possess physical dimensions that provide light emitting characteristics sufficient to satisfy requirements of various standardization and regulatory bodies. This problem is most seen in high “wattage” lamp replacements such as 60-150 W bulb replacements.

Another problem with white LEDs is the directionality of their light emission. White LEDs are highly directional light emitting devices. But many lamps, such as the most common A-19 lamps (bulb) radiate light evenly in all directions (omnidrectional). This makes it difficult for white LEDs mounted on a single circuit board to emit light in a similar pattern to a conventional lamp.

A further problem with white LEDs is emission color over emission angle. It is common for white LEDs to have “fringe” effects where the light color is not the same at the edges of emission as the center. This is an even bigger problem with array products that may use red and white LEDs together. Creating a uniform, omnidirectional light with no shift in color based on angle are key features needed to address the lamp market with LED replacement lamps.

Therefore, there is a need for an improved approach to implement LED lamps to address these and other problems with conventional technologies.

### SUMMARY OF THE INVENTION

Embodiments of the invention concern photoluminescence wavelength conversion components with improved emission efficiency and solid-state lamps utilizing such components. More particularly, although not exclusively, embodiments of the invention concern solid-state lamps and photoluminescence components that generate light with a substantially omnidirectional emission characteristic.

According to an embodiment of the invention a photoluminescence component comprises a light transmissive hollow component defining an interior volume and having a substantially circular cross section, a substantially circular opening and at least one photoluminescence material which generates light in response to excitation light, wherein the ratio of the opening diameter to maximum internal diameter is in a range between 1 to 1.25 and 1 to 2.5. In some embodiments the ratio of the opening diameter to maximum internal diameter is in a range between 1 to 1.6 and 1 to 2.0.

In some embodiments the ratio of the maximum internal diameter to the length of the component in an axial direction is in a range between 1 to 0.8 to 1 to 1.2.

The component can be fabricated from a resiliently deformable light transmissive material such as a silicone material. Since the opening of the component is smaller than the maximum internal diameter using a resiliently deformable material provides the benefit of enabling easy removal of the component from a former on which the component is molded. Alternatively the component can be fabricated from a semi rigid material such as a polycarbonate, PET, clear PVC or an acrylic by for example injection molding. Injection molding is a high speed process that has been proven to work well for these components. When the component is fabricated from a material that is not flexible the component can be fabricated in two parts thereby eliminating the need to use a collapsible former during the molding process. The photoluminescence material which typically comprises a phosphor material can be homogeneously distributed throughout the volume of the component as part of the molding process. Alternatively the photoluminescence material can be provided as one or layers on the inner or outer surfaces of the component.

According to an embodiment of the invention a photoluminescence component comprises: a light transmissive hollow component defining an interior volume and having a substantially circular cross section, a substantially circular opening and at least one photoluminescence material which generates light in response to excitation light, wherein the ratio of the maximum internal diameter to the length of the component in an axial direction is in a range between 1 to 0.8 and 1 to 1.2. In some embodiments the length of the component and the maximum internal diameter are substantially equal.

According to an embodiment of the invention a photoluminescence component comprises: a light transmissive hollow component defining an interior volume and having an opening that is smaller than a maximum internal dimension of the component, wherein the component comprises a photoluminescence material which generates light in response to excitation light and wherein in operation when excited by excitation light from an excitation source located at or near said opening the component emits light over angles of at least 0° to ±135° with a variation in emission luminous intensity of less than about 20%.

To ensure a uniform radial emission the component typically has a cross section that is substantially circular.

According to an embodiment of the invention a solid-state lamp comprises: at least one solid-state excitation source operable to generate excitation light and a photoluminescence component mountable over said at least one excitation source, wherein the component comprises a light transmissive hollow component defining an interior volume and having a substantially circular cross section, a substantially circular opening of diameter that is smaller than the maximum internal diameter of the component, wherein the component comprises at least one photoluminescence material which generates light in response to excitation light and wherein in operation the lamp emits light over angles of 0° to ±135° with a variation in emission luminous intensity of less than about 20%.

The lamp can further comprise a light diffusive cover enclosing the component.

According to an embodiment of the invention a photoluminescence component comprises: a light transmissive hollow component defining an interior volume and having a substantially circular cross section, a substantially circular opening and at least one photoluminescence material which generates light in response to excitation light, wherein the ratio of the opening diameter to length of the component in an axial direction is at least 1 to 1.5. Preferably the opening diameter to the length of the component is at least 1 to 3.

Some embodiments of the invention utilize a solid component instead of a hollow shell. The solid component permits the interior of the wavelength conversion component to comprise a material possessing an index of refraction that more closely matches the index of refraction for the wavelength conversion component and/or the LEDs. This allows light to be emitted to, within, and/or through the interior volume of the wavelength conversion component without having to incur losses caused by excessive mismatches in the indices of refraction for an air interface. Since the boundaries between the LEDs, the solid optical component, and the wavelength conversion component all generally match, this greatly reduces the amount of light that is lost due to the light coupling effects of the solid optical component. This permits the lamp to significantly increase the amount of light output for a given quantity of input power. This also means that much less heat is produced by the loss of the light.

According to some embodiments, the LED lamp includes a wavelength conversion component and an array of LEDs, e.g., an array of red LEDs and blue LEDs. In some embodiments, the array of blue and red LEDs comprises generally a 2 blue to 1 red or 3 blue to 1 red ratio. In some embodiments, only blue LEDs are used in the LED array. The interior volume of the wavelength conversion component is not filled with air, but is instead filled with a solid optical component, which eliminates and/or significantly reduces any air interface between the wavelength conversion component and an array of LEDs. This facilitates light coupling for any light that traverses through the interior volume of the wavelength conversion component.

According to some embodiments, the composition of the solid optical component is selected to possess an index of refraction that generally matches the index of refraction for the wavelength conversion component and/or the LEDs. For example, the solid optical component may be selected of a material, e.g. silicone, to generally fall within or match a range of 1.4 to 1.6. A high refractive index material in the LED package facilitates effective blue light extraction from the LED, and the use of a silicone or similar polymer in the center of this shape that couples from the LED to the outer remote phosphor also serves for improving light extraction from the LED. This makes it possible for arrays of LEDs to be used without the need for clear lenses or domes on each LED. Light extraction can be implemented in a manner that decreases the cost in the LED packaging by integrating the light extraction and remote phosphor features into a single device.

The wavelength conversion component may be formed of any suitable shape or configuration. In some embodiments, a wavelength conversion component has an elongated conical shape, e.g. a shape where the rate of the height (h) to the width (w) is greater than 1, and is at least a ratio of 2. As another example of a shape, the wavelength conversion component may be substantially or generally cylindrical at its end closest to the array, and may be tapered to a point at its end furthest from the array. In certain applications, this ratio permits better light distribution properties for the LED lamps that employ such components. In particular, since the present invention allows for lowered levels of heat generation, this means that the LED lamp can employ smaller thermal management structures for a given light output/power for the lamp. A more elongated structure for the wavelength conversion component, in combination with smaller heat sink sizes, permits better light distribution and emissions characteristics, e.g., for emissions in downwards directions in applications that use LED lamps as bulbs for a desk light.

Some embodiments are directed to inventive approaches for manufacturing an LED lamp and/or LED lamp components. To manufacture a wavelength conversion component, phosphor material can be mixed with a light transmissive polymer, and the polymer/phosphor mixture extruded or injection molded to form the wavelength conversion component with the phosphor material homogeneously distributed throughout the volume of the component. A heating process may be used to melt and mix the phosphor material with the polymer material, which is then cooled to form the final shape of the wavelength conversion component. Hot runners may be employed to ensure efficient usage of the constituent components for the molding process. Vacuum molding may also be employed to manufacture the three-dimensional wavelength conversion components. Various approaches may be taken to introduce the solid optical component into the interior volume of the wavelength conversion component. The solid optical component may be composed of an index matching gel or liquid material, which is poured into the interior volume formed by the inner surfaces of the wavelength conversion component. A curing process is then employed to cure the index matching gel or liquid material into its final solid form, e.g. by application of heat or UV light. An injection molding and/or co-extrusion process may also be used to introduce the solid optical component into the interior volume of the wavelength conversion component. The solid optical component may be formed to include an open portion, where the open portion is sized to adequately fit one or more LEDs. As another example, a solid optical component may be separately fabricated, then attached to the wavelength conversion component in any suitable manner, such as by interference fit, pressure fit, or adhesive. Optionally, an index matching material is poured into the open portion in sufficient quantities to remove any air spaces when the circuit board is attached. The circuit board is then attached to the assembly. The index matching material is then cured into a solid to form the final product.

In an alternative approach for manufacturing an LED lamp and/or LED lamp components, the circuit board containing the LEDs is attached to the wavelength conversion component before introduction of the solid optical component. An opening exists to introduce the index matching material, where the opening may be formed into any of the components of the assembly. For example, the opening may be formed in the circuit board, or alternatively, the opening may be formed in the wavelength conversion component. The index matching material is poured through the opening into the interior volume of the wavelength conversion component. Enough of the index matching materiel is added to remove any air spaces within the interior volume, and the index matching material is then cured into a solid to form the solid optical component.

Some embodiments of the invention comprise a diffuser layer having particles of a light diffusive material (also referred to herein as “light scattering material”). One benefit of this arrangement is that by selecting an appropriate particle size and concentration per unit area of the light diffractive material, it is possible to make a device having an emission product color that is virtually uniform with emission angle over a ±60° range from the emission axis. Moreover the use of a light scattering material can substantially reduce the quantity of phosphor material required to generate a selected color of emitted light. In addition, the light diffusing material can significantly improve the white appearance of the light emitting device in its OFF state. The particles of a light diffractive material in the light diffusing layer are selected, for example, to have a size range that increases its probability of scattering blue light, which means that less of the external blue light passes through the light diffusing layer to excite the wavelength conversion layer. Therefore, the remote phosphor lighting apparatus will have more of a white appearance in an OFF state since the wavelength conversion component is emitting less yellow/red light. Preferably, to enhance the white appearance of the lighting device in an OFF state, the light diffractive material within the light diffusing layer is a “nano-particle” having an average particle size of less than about 150 nm. For light sources that emit lights having other colors, the nano-particle may correspond to other average sizes. For example, the light diffractive material within the light diffusing layer for an UV light source may have an average particle size of less than about 100 nm. Therefore, by appropriate selection of the average particle size of the light scattering material, it is possible to configure the light diffusing layer such that it scatters excitation light (e.g., blue light) more readily than other colors, namely green and red as emitted by the photoluminescence materials. For example, TiO₂ particles with an average particle size of 100 nm to 150 nm are more than twice as likely to scatter blue light (450 nm to 480 nm) than they will scatter green light (510 nm to 550 nm) or red light (630 nm to 740 nm). As another example, TiO₂ particles with an average particle size of 100 nm will scatter blue light nearly three times (2.9=0.97/0.33) more than it will scatter green or red light. For TiO₂ particles with an average particle size of 200 nm these will scatter blue light over twice (2.3=1.6/0.7) as much as they will scatter green or red light. In accordance with some embodiments of the invention, the light diffractive particle size is preferably selected such that the particles will scatter blue light relatively at least twice as much as light generated by the phosphor material(s).

Another problem with remote phosphor devices that can be addressed by embodiments of the invention is the variation in color of emitted light with emission angle. This problem is commonly called COA (Color Over Angle). Improved Color Over Angle—Remote phosphor layers allow a certain amount of blue light to escape as the blue component of white light. This is directional light coming from the LEDs. The RGY (Red Green Yellow) light coming from the phosphor is lambertian. Therefore the directionality of the blue light may be different than that of the RGY light causing a “halo” effect at the edges with color looking “cooler” in the direction of the blue LED light and “warmer” at the edges where the light is all RGY. The addition of nano-diffuser selectively diffuses blue light—causing it to have the same lambertian pattern as the RGY light and creating a very uniform color over angle. Traditional LEDs also have this problem which can be improved by remote phosphor using this technology.

Improved Red Blue systems—some LED systems are using red and blue LEDs. The native red LEDs are a very efficient source of red light and eliminate the need for costly red phosphor. However, blending red and blue light with phosphor light and also avoiding loss of the red light during pass though is critical. Remote phosphor with nano-diffuser selectively scatters blue, allows red to pass through without high loss and provides a very effective mixing of the light to avoid color over angle and other color separation effects. In particular, remote phosphor devices are often subject to perceptible non-uniformity in color when viewed from different angles. Embodiments of the invention correct for this problem, since the addition of a light diffusing layer in direct contact with the wavelength conversion layer significantly increases the uniformity of color of emitted light with emission angle θ.

Embodiments of the present invention can be used to reduce the amount of phosphor materials that is required to manufacture an LED lighting product, thereby reducing the cost of manufacturing such products given the relatively costly nature of the phosphor materials. In particular, the addition of a light diffusing layer composed of particles of a light diffractive material can substantially reduce the quantity of phosphor material required to generate a selected color of emitted light. This means that relatively less phosphor is required to manufacture a wavelength conversion component as compared to comparable prior art approaches. As a result, it will be much less costly to manufacture lighting apparatuses that employ such wavelength conversion components, particularly for remote phosphor lighting devices.

Some embodiments include the light scattering material in a separate layer on the LED lamp. Another approach is to include the light scattering material within the wavelength conversion component. Yet another approach is to introduce the light scattering material into the solid optical component.

According to an embodiment of the invention a lamp comprises: an array of solid-state excitation sources; a photoluminescence component that comprises a layer of photoluminescence material and a coupling optic, the layer of photoluminescence material is remote from the array of solid-state excitation sources, wherein the coupling optic is disposed between the array of solid-state excitation sources and the layer of photoluminescence material; and wherein a photoluminescence material surface area for the layer of the photoluminescence material has a 3 to 1 ratio as compared to an excitation source surface area for the array of solid-state excitation sources.

In some embodiments the layer of the photoluminescence material corresponds to an aspect ratio greater than 1 to 1.

### BRIEF DESCRIPTION OF THE DRAWINGS

In order that the present invention is better understood solid-state lamps and photoluminescence wavelength conversion components in accordance with embodiments of the invention will now be described, by way of example only, with reference to the accompanying drawings in which:

FIG. 1 is a schematic representation of an LED-based lamp in accordance with an embodiment of the invention;

FIGS. 2A and 2B respectively show side and perspective views of a photoluminescence wavelength conversion component in accordance with an embodiment of the invention for use in the lamp of FIG. 1;

FIG. 3 is a polar diagram of emitted luminous intensity versus angle for the lamp of FIG. 1 without a light diffusive cover;

FIG. 4 is a polar diagram of emitted luminous intensity versus angle for the lamp of FIG. 1 with a light diffusive cover;

FIGS. 5A and 5B respectively show side and perspective views of a photoluminescence wavelength conversion component in accordance with an embodiment of the invention;

FIGS. 6A and 6B respectively show perspective views of a photoluminescence wavelength conversion component in accordance with an embodiment of the invention;

FIGS. 7A and 7B respectively show lamps with a phosphor encapsulation and a remote photoluminescence wavelength conversion component;

FIGS. 8A and 8B respectively show cross sectional side and plan views of an LED lamp having a solid optical component according to some embodiments of the invention;

FIG. 8C is a cross sectional side view of the solid optical component of the lamp of FIGS. 8A and 8B;

FIGS. 8D and 8E respectively show perspective views of a photoluminescence wavelength conversion component in accordance with an embodiment of the invention;

FIGS. 9A-9E are schematic representations of a process for manufacturing an LED lamp in accordance with an embodiment of the invention;

FIGS. 10A-10F are schematic representations of a process for manufacturing an LED lamp in accordance with an alternate embodiment of the invention;

FIGS. 11A-11G are schematic representations of a process for manufacturing an LED lamp in accordance with an another embodiment of the invention; and

FIGS. 12A-12F illustrate LED lamps having diffuser components in accordance with embodiments of the invention.

### DETAILED DESCRIPTION OF THE INVENTION

Lamps (light bulbs) are available in a number of forms, and are often standardly referenced by a combination of letters and numbers. The letter designation of a lamp typically refers to the particular shape of type of that lamp, such as General Service (A, mushroom), High Wattage General Service (PS—pear shaped), Decorative (B—candle, CA—twisted candle, BA—bent-tip candle, F—flame, P—fancy round, G—globe), Reflector (R), Parabolic Aluminized Reflector (PAR) and Multifaceted Reflector (MR). The number designation refers to the size of a lamp, often by indicating the diameter of a lamp in units of eighths of an inch. Thus, an A-19 type lamp refers to a general service lamp (bulb) whose shape is referred to by the letter “A” and has a maximum diameter two and three eights of an inch. As of the time of filing of this patent document, the most commonly used household “light bulb” is the lamp having the A-19 envelope, which in the United States is commonly sold with an Edison E26 screw base.

There are various standardization and regulatory bodies that provide exact specifications to define criteria under which a manufacturer is entitled to label a lighting product using these standard reference designations. With regard to the physical dimensions of the lamp, ANSI provides the specifications (ANSI C78.20-2003) that outline the required sizing and shape by which compliance will entitle the manufacture to permissibly label the lamp as an A-19 type lamp. Besides the physical dimensions of the lamp, there may also be additional specifications and standards that refer to performance and functionality of the lamp. For example in the United States the US Environmental Protection Agency (EPA) in conjunction with the US Department of Energy (DOE) promulgates performance specifications under which a lamp may be designated as an “ENERGY STAR” compliant product, e.g. identifying the power usage requirements, minimum light output requirements, luminous intensity distribution requirements, luminous efficacy requirements and life expectancy.

A problem facing solid-state lighting designers is that the disparate requirements of the different specifications and standards create design constraints that are often in tension with one another. For example, the A-19 lamp is associated with very specific physical sizing and dimension requirements, which is needed to make sure A-19 type lamps sold in the marketplace will fit into common household lighting fixtures. However, for an LED-based replacement lamp to be qualified as an A-19 replacement by ENERGY STAR, it must demonstrate certain performance-related criteria that are difficult to achieve with a solid-state lighting product when limited to the form factor and size of the A-19 light lamp.

For example, with respect to the luminous intensity distribution criteria in the ENERGY STAR specifications, for an LED-based replacement lamp to be qualified as an A-19 replacement by Energy Star it must demonstrate an even (+/−20%) light distribution over 270° and emit a minimum of 5% light above 270°. One issue is that LED replacement lamps need electronic drive circuitry and an adequate heat sink area; in order to fit these components into an A-19 form factor, the bottom portion of the lamp is replaced by a thermally conductive housing that acts as a heat sink and houses the driver circuitry needed to convert AC power to low voltage DC power used by the LEDs. A problem created by the housing of an LED lamp is that it blocks light emission in directions towards the base as is required to be ENERGY STAR compliant. As a result many LED lamps lose the lower light emitting area of traditional bulbs and become directional light sources, emitting most of the light out of the top dome (180° pattern) and virtually no light downward since it is blocked by the heat sink (body), which frustrates the ability of the lamp to comply with the luminous intensity distribution criteria in the ENERGY STAR specification.

As indicated in Table 1, LED lamps targeting replacement of the 100 W incandescent light lamps need to generate 1600 lumens, for 75 W lamp replacements 1100 lumens and for 60 W lamp replacements 800 lumens. This light emission as a function of wattage is non-linear because incandescent lamp performance is non-linear.

TABLE 1
Minimum light output of omnidirectional LED lamps
for nominal wattage of lamp to be replaced

| Nominal wattage of lamp to be | Minimum initial light output of |
|---|---|
| replaced (Watts) | LED lamp (lumens) |
| 25 | 200 |
| 35 | 325 |
| 40 | 450 |
| 60 | 800 |
| 75 | 1,100 |
| 100 | 1,600 |
| 125 | 2,000 |
| 150 | 2,600 |

Replacement lamps also have dimensional standards. As an example an A-19 lamp should have maximum length and diameter standards of 3½ inches long and 2⅜ inches in diameter. In LED lamps this volume has to be divided into a heat sink portion and a light emitting portion. Generally the heat sink portion is at the base of the LED lamp and usually requires 50% or even more of the lamp length for 60 W and higher wattage equivalent replacement lamps.

Additionally white LEDs are directional point light sources. If packaged in an array without a light diffusive (diffuser) dome or other optical cover they appear as an array of very bright spots, often called “glare”. Such glare is undesirable in a lamp replacement with a larger smooth light emitting area similar to traditional incandescent bulbs being preferred. In addition to glare, LEDs mounted on a PCB (Printed Circuit Board) surface will directionally broadcast light in a pattern of 150° or less. To compensate for this an aggressive diffuser bulb may be used but this will reduce efficiency and also increase the thermal insulation of the LEDs increasing the thermal problems of cooling.

Currently LED replacement lamps are considered too expensive for the general consumer market. Typically an A-19, 40 W replacement LED lamp costs many times the cost of an incandescent bulb or compact fluorescent lamp. The high cost is due to the complex and expensive construction and components used in these lamps.

Embodiments of the present invention address, at least in part, each of the above issues.

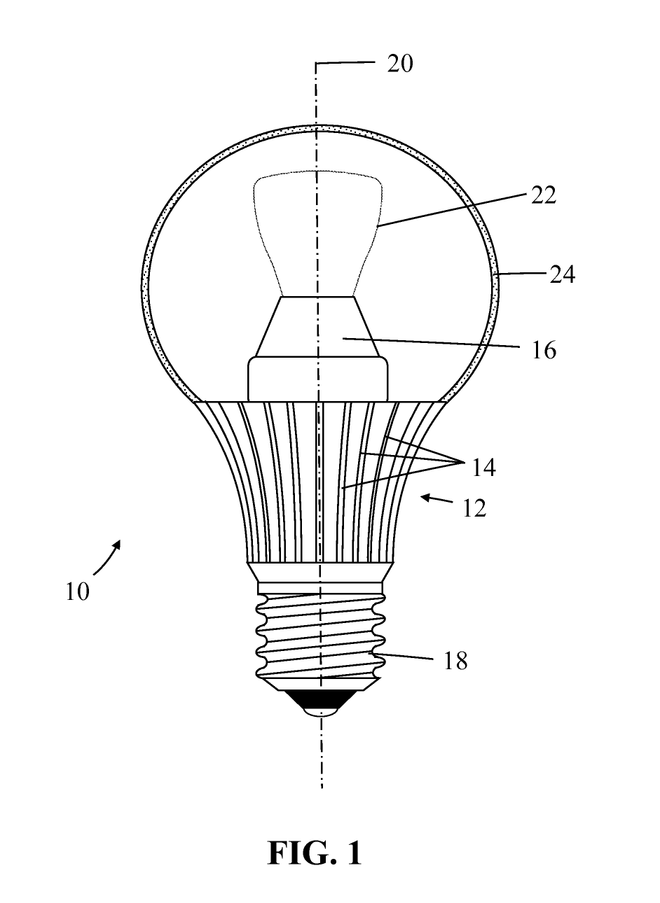

Referring to FIG. 1 an LED lamp 10 in accordance with an embodiment of the invention comprises a generally conical shaped thermally conductive body 12. The body 12 is a solid body whose outer surface generally resembles a frustrum of a cone; that is, a cone whose apex or vertex is truncated by a plane that is parallel to the base (i.e. substantially frustoconical). The body 12 is made of a material with a high thermal conductivity (typically ≧150 Wm⁻¹K⁻¹, preferably ≧200 Wm⁻¹K⁻¹) such as for example aluminum (≈250 Wm⁻¹K⁻¹), an alloy of aluminum, a magnesium alloy, a metal loaded plastics material such as a polymer, for example an epoxy. Conveniently the body 12 can be die cast when it comprises a metal alloy or molded, by for example injection molding, when it comprises a metal loaded polymer.

A plurality of latitudinal radially extending heat radiating fins (veins) 14 is circumferentially spaced around the outer curved surface of the body 12. Since the lamp is intended to replace a conventional incandescent A-19 light bulb the dimensions of the lamp are selected to ensure that the device will fit a conventional lighting fixture and comply with ENERGY STAR requirements. The body 12 further comprises a conical shaped thermally conductive pedestal 16 portion projecting from the base of the body.

The lamp 10 can further comprise an E26 connector cap (Edison screw lamp base) 18 enabling the lamp to be directly connected to a mains power supply using a standard electrical lighting screw socket. It will be appreciated that depending on the intended application other connector caps can be used such as, for example, a double contact bayonet connector (i.e. B22d or BC) as is commonly used in the United Kingdom, Ireland, Australia, New Zealand and various parts of the British Commonwealth or an E27 screw base (Edison screw lamp base) as used in Europe. The connector cap 18 is mounted to the truncated apex of the body 12 and the body electrically isolated from the cap.

A plurality (four in the exemplary embodiment) of blue LEDs (not shown) are mounted as an annular array on an annular shaped MCPCB (metal core printed circuit board) which is mounted in thermal communication with the top of the conical pedestal 16. The metal core base of the MCPCB can be mounted to the pedestal with the aid of a thermally conducting compound such as for example an adhesive containing a standard heat sink compound containing beryllium oxide or aluminum nitride. Rectifier and/or other driver circuitry for operating the LEDs directly from a mains power supply can be housed within an internal cavity (not shown) within the body 12.

Each LED can comprise a 2 W gallium nitride-based blue light emitting LED which are operable to generate blue light with a dominant wavelength of 455 nm-460 nm. The LEDs are configured such that their principle emission axis is parallel with the axis 20 of the lamp. In other embodiments the LEDs can be configured such that their principle emission axis is in a generally radial direction. A light reflective mask can be provided overlaying the MCPCB that includes apertures corresponding to each LED to maximize light emission from the lamp.

The lamp further comprises a light transmissive wavelength conversion component 22 that includes one or more photoluminescence materials. In some embodiments, the photoluminescence materials comprise phosphors. For the purposes of illustration only, the following description is made with reference to photoluminescence materials embodied specifically as phosphor materials. However, the invention is applicable to any type of photoluminescence material, such as either phosphor materials or quantum dots. A quantum dot is a portion of matter (e.g. semiconductor) whose excitons are confined in all three spatial dimensions that may be excited by radiation energy to emit light of a particular wavelength or range of wavelengths. The phosphor material can comprise an inorganic or organic phosphor such as for example silicate-based phosphor of a general composition A₃Si(O,D)₅ or A₂Si(O,D)₄ in which Si is silicon, O is oxygen, A comprises strontium (Sr), barium (Ba), magnesium (Mg) or calcium (Ca) and D comprises chlorine (Cl), fluorine (F), nitrogen (N) or sulfur (S). Examples of silicate-based phosphors are disclosed in U.S. Pat. No. 7,575,697 B2 “Silicate-based green phosphors” (assigned to Internatix Corp.), U.S. Pat. No. 7,601,276 B2 “Two phase silicate-based yellow phosphors” (assigned to Internatix Corp.), U.S. Pat. No. 7,655,156 B2 “Silicate-based orange phosphors” (assigned to Internatix Corp.) and U.S. Pat. No. 7,311,858 B2 “Silicate-based yellow-green phosphors” (assigned to Internatix Corp.). The phosphor can also comprise an aluminate-based material such as is taught in co-pending patent application US2006/0158090 A1 “Novel aluminate-based green phosphors” and U.S. Pat. No. 7,390,437 B2 “Aluminate-based blue phosphors” (assigned to Internatix Corp.), an aluminum-silicate phosphor as taught in co-pending application US2008/0111472 A1 “Aluminum-silicate orange-red phosphor” or a nitride-based red phosphor material such as is taught in co-pending United States patent applications US2009/0283721 A1 “Nitride-based red phosphors” and US2010/074963 A1 “Nitride-based red-emitting in RGB (red-green-blue) lighting systems”. It will be appreciated that the phosphor material is not limited to the examples described and can comprise any phosphor material including nitride and/or sulfate phosphor materials, oxy-nitrides and oxy-sulfate phosphors or garnet materials (YAG).

As shown in FIG. 1 the photoluminescence wavelength conversion component 22 is mounted over the LEDs on top of the pedestal 16 and fully encloses the LEDs. The lamp can further comprise a light diffusive envelope or cover 24 mounted to the base of the body and encloses the component 22. The cover 24 can comprise a glass or a light transmissive polymer such as a polycarbonate, acrylic, PET or PVC that incorporates or has a layer of light diffusive (scattering) material. Example of light diffusive materials include particles of Zinc Oxide (ZnO), titanium dioxide (TiO₂), barium sulfate (BaSO₄), magnesium oxide (MgO), silicon dioxide (SiO₂) or aluminum oxide (Al₂O₃).

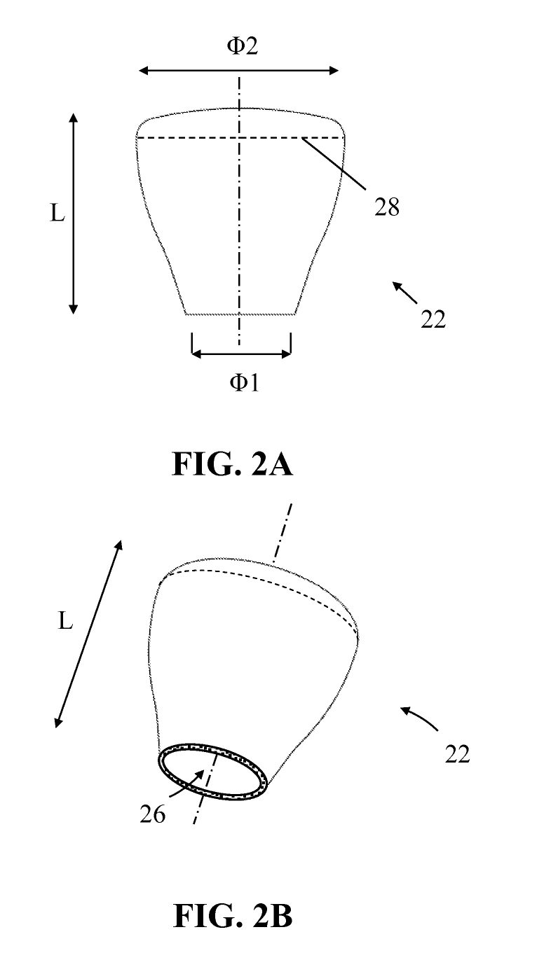

As shown in more detail in FIGS. 2A and 2B the photoluminescence wavelength conversion component 22 can comprise a generally dome/knob shaped shell (i.e. a hollow component). Candle (ellipsoidal) shapes are also used especially when the application are decorative lamps used in chandelier type applications. The component has a circular opening 26 of diameter Φ1 which is smaller that a maximum inner diameter Φ2. In the embodiment illustrated the ratio of the opening diameter to maximum diameter is approximately 1:1.9. The component has an axial length L. In the embodiment shown the length L of the component is approximately equal to the maximum diameter of the component and the aspect ratio of the component 22 in an axial direction (ratio of opening diameter Φ1 to length L) is approximately 1:2. As is described further the relative dimensions and shape of the component can affect the radial emission pattern of the component and are configured to give a required emission pattern.

In some embodiments the component is fabricated from a resiliently deformable (semi-flexible) light transmissive material such as a silicone material. Silicone is also an injection moldable material—however the injection molding is done when the material is cold. The mold is then heated and the parts start to “set” in the mold. A silicone part can be ejected when it is still flexible allowing it to be stretched and frequented ejected by compressed air off of the mold core. In this way bulb like shapes can be made with simple molds. Also silicone is a high temperature material. Silicone can withstand temperatures of 150-200° C. and even higher. PVC is one of the higher temperature clear plastics, but extended operating temperature is often limited to 105° C. Acrylic and PET have significantly lower maximum operating temperatures. This makes silicone preferred for higher lumen applications where more heat and light is generated. A benefit of using a resiliently deformable material is that this assists in removal of the component from a former on which the component is molded. Alternatively the component can be fabricated from a semi rigid material by injection molding and be fabricated from polycarbonate or acrylic. When the component is fabricated from a material that is not flexible the component can be fabricated in two parts thereby eliminating the need to use a collapsible former during the molding process. In FIG. 2A dashed line 28 indicates an example of how the component can be split into two parts by a plane in a radial direction. Alternatively the component can be split into two or more parts by a plane in an axial direction. In some embodiments the photoluminescence material can be homogenously distributed throughout the volume of the component 22 as part of the molding process. Alternatively the photoluminescence material can be provided as a layer on the inner or outer surfaces of the component.

In operation the LEDs generate blue excitation light a portion of which excite the photoluminescence material within the wavelength conversion component 22 which in response generates by a process of photoluminescence light of another wavelength (color) typically yellow, yellow/green, orange, red or a combination thereof. The portion of blue LED generated light combined with the photoluminescence material generated light gives the lamp an emission product that is white in color.

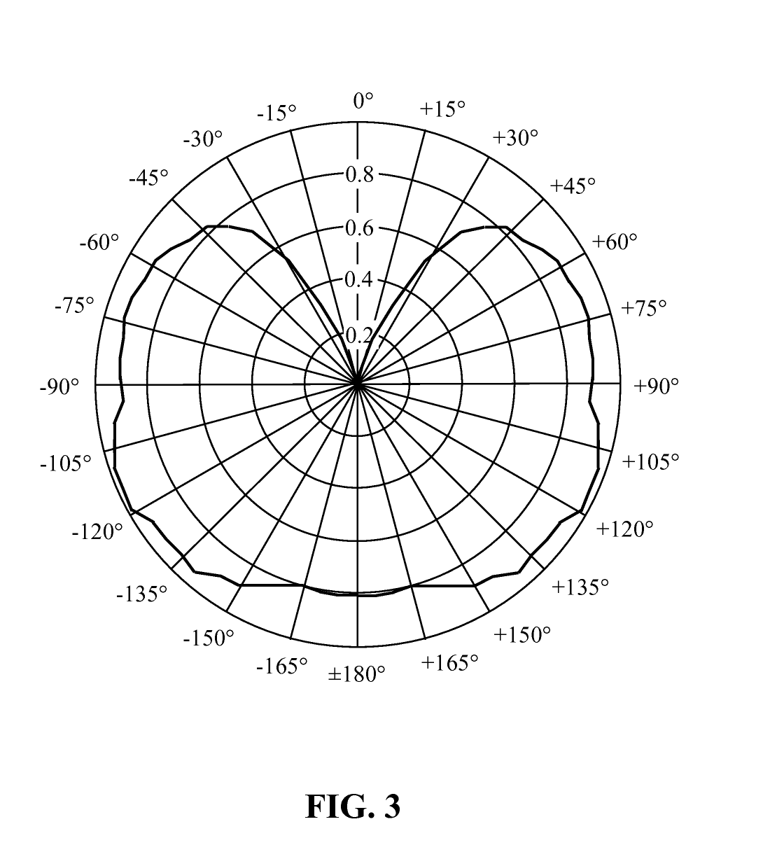

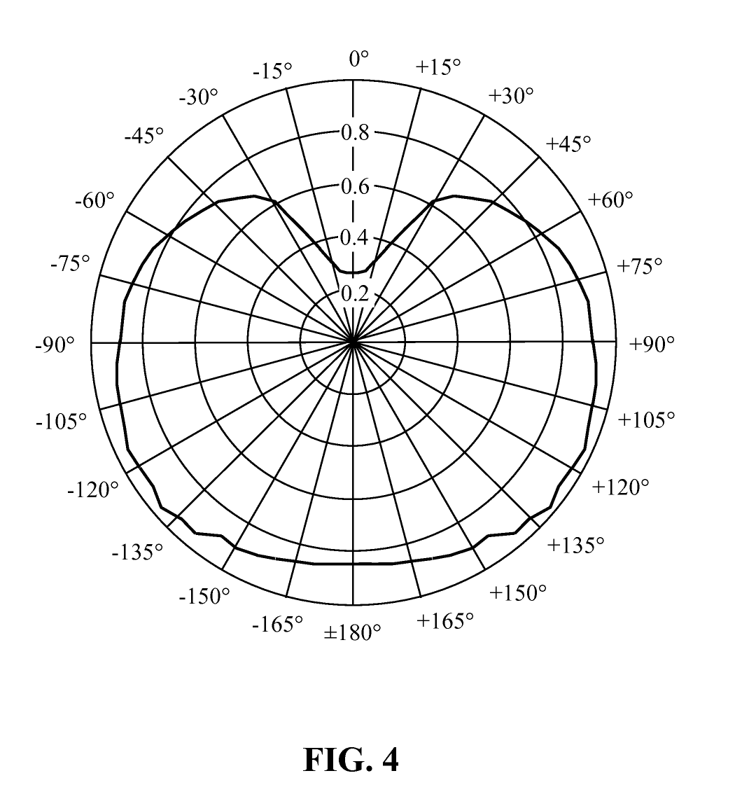

FIGS. 3 and 4 respectively show polar diagram of emitted luminous intensity versus angle for the lamp of FIG. 1 without and with the light diffusive cover 24. As can be seen from these figures the lamp 10, in particular the component 22, emits light substantially omnidirectionally. For example over an angular range of 0° to ±135° (total 270°) there is a variation in luminous intensity of less than 20%. Furthermore the lamp emits a proportion of light (about 5%) in an angular range 135° to 170°.

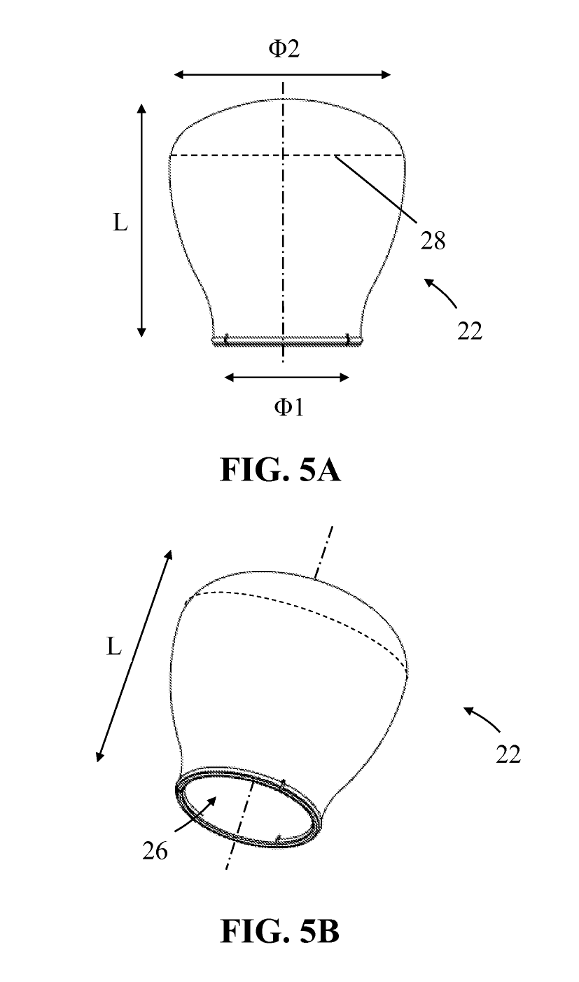

FIGS. 5A and 5B show side and perspective views of a hollow photoluminescence wavelength conversion component in accordance with an embodiment of the invention. In the embodiment illustrated in FIG. 5 the ratio of the opening diameter Φ1 to maximum diameter Φ2 is approximately 1:1.6 and the aspect ratio of the component is approximately 1:1.75.

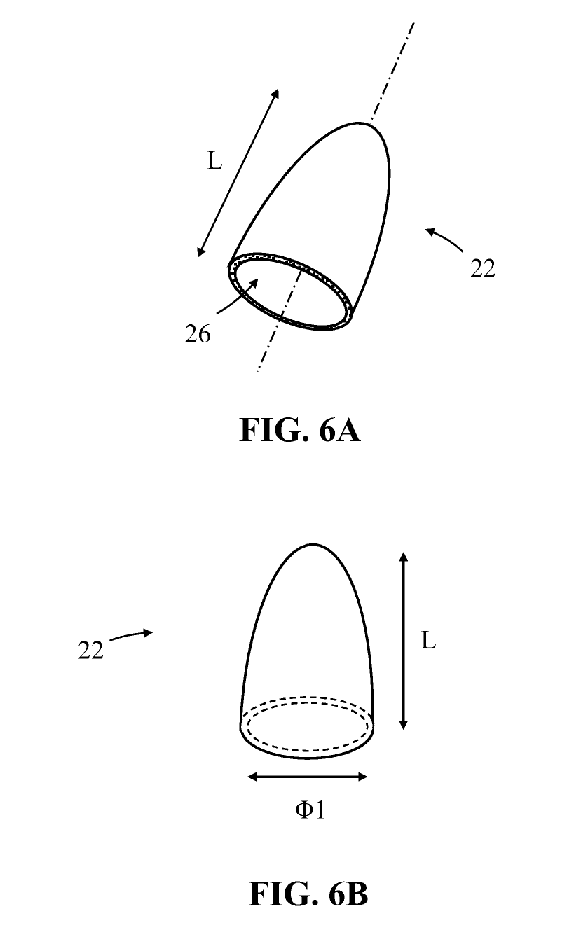

FIGS. 6A and 6B show perspective and side views of a photoluminescence wavelength conversion component in accordance with an embodiment of the invention. In this embodiment the component comprises a hemi-ellipsoidal dome (shell). As can be seen in the embodiment illustrated in FIG. 6 opening diameter Φ1 is the maximum diameter and the aspect ratio of the component is 1:1.6. In other embodiments the ratio of the opening diameter to maximum diameter can be in a range 1:1.25 to 1:2.5. In other embodiments the ratio of the maximum internal diameter to the length of the component is in a range 1:0.8 to 1:1.2.

As will be described below the inventors have discovered that as well as improving the emission distribution pattern, photoluminescence wavelength conversion components in accordance with embodiments of the invention can also improve overall light emission efficiency. For example preliminary tests indicate that the hollow (shell) wavelength conversion components described can gives a total light emission that is up to about 7% greater than the known wavelength conversion components. It is believed that the increase in emission efficiency results from the component having an aspect ratio of greater than 1:1.5. It is hypothesized that such as shape reduces the possibility of re-absorption of light by the LED(s) positioned at the opening of the component.

Whilst the photoluminescence component has been described as comprising a hollow shell it is contemplated in other embodiments that it comprises a solid optical component. The inventors have discovered that filling the component with a light transmissive medium or manufacturing a solid component with a light transmissive core offers unexpected benefits which are now described.

System Quantum Efficiency (SQE)

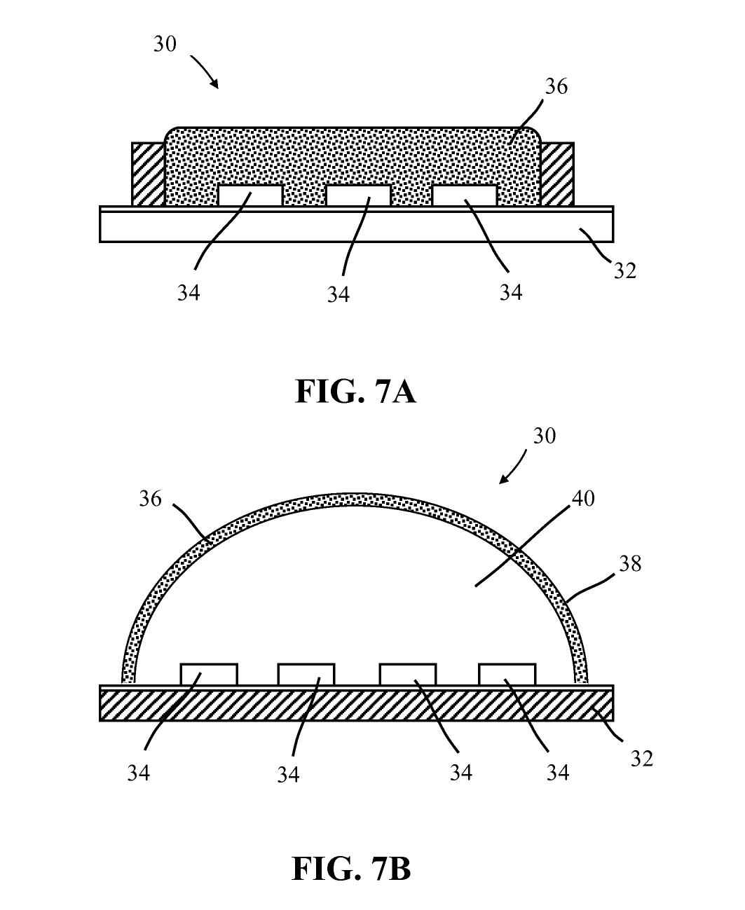

White LEDs and LED arrays are typically constructed of blue LEDs encapsulated with a layer of silicone containing particles of a powdered phosphor material (FIG. 7A) or covered using a wavelength conversion component (optic) including the phosphor material (FIG. 7B). The encapsulation or optic can be planar or domed shaped. The inventors have discovered the system quantum efficiency (SQE) of the known white LED and LED arrays is typically only up to 70% and at best 80%. In this patent specification the “system quantum efficiency” is defined as the ratio of the total number of photons produced by the system to the number of photons generated by the LED. It will be appreciated that the SQE does not include the LED quantum efficiency (i.e. the efficiency of the LED to convert electrical power to photons). Since the phosphor quantum efficiency can be 97% and higher depending on the specific phosphor composition, the inventors have discovered that 20% or more of the total light is being lost during conversion of the blue LED light to white light. The SQE can be determined by measuring the total number of blue photons emitted by the blue LED(s) emit without phosphor (generally with a clear silicone dome for enhancing blue light extraction). Using the same LED(s) with the phosphor layer or optic the total number of photons is the measured. The ratio of the number blue photons before conversion to white photons after conversion represents the SQL. The theoretical maximum SQL (100%) is one white photon created from every blue photon supplied.

As described earlier the SQL of known white LED systems are 70-80% or less. The inventors have determined that the majority of light loss is not due to the photoluminescence conversion process but rather due to absorption losses for light (both photoluminescence and LED light) that is emitted back into the LED(s). Due to the photoluminescence conversion process being isotropic, photoluminescence light will be emitted in all directions and hence up to about 50% will be generated in a direction back towards the LED(s) giving rise to re-absorption and loss of photoluminescence light by the LED(s). Photoluminescence components of the present invention substantially reduce or even virtually eliminate SQE losses making it possible to achieve a SQE of 95% and greater. The result is 20% or more improvement in light output as well as cooler operation or reduced power consumption by the LED system. All of these are benefits for LED lighting systems.

SQE Light Loss

In order to more fully understand the light loss mechanism in a known white LED system is now described with reference to FIG. 7A which shows a schematic cross-sectional view of a white LED system 30 comprising a circuit board 32 with an array of LEDs 34, a so-called COB (Chip-On-Board) arrangement. The phosphor material(s) 36 is provided as an encapsulating layer over the array of LED chips. In this illustration blue light is emitted by the LEDs 34 into the phosphor layer 36 where a proportion is converted to light of a different color (e.g. yellow, green, red or a combination) through a photoluminescence process. As described earlier since the photoluminescence process is isotropic approximately 50% of the phosphor generated light will be emitted in a direction back towards the circuit board 32 and LED chips 34. In addition to phosphor generated light returning in the direction of the LED chips, approximately 50% of the blue light that is not converted by the phosphor will be scattered in a direction back towards the circuit board and LED chips. In a typical white LED system between 10 and 20% of the total blue light is scattered towards the LED chips and circuit board.

The majority of the light (measured values of 60% is common) does not exit the system in a first pass and actually returns in the direction of the LED chips/circuit board. For this reason LED developers have gone to great lengths to use high reflectance materials for surface of the circuit board (or other package) to maximize light emission from the system. The result is a light “cycling” behavior. A package and LED reflectance of 90% is considered high. Table 2 tabulates the predicted losses from light cycling assuming a 90% efficient package and 60% light returning into LED package. This would be considered state of art performance in conventional LED packaging.

As can be seen from Table 2 this indicates a SQE of 78%. As long as the layer structure attached to the LED contains phosphor it will statistically emit approximately 50% of converted light back in the direction of the LED and package. Add to this the reflection and diffusion effect and we see the loss mechanism that is limiting LED array performance.

TABLE 2
Predicted SQE losses for a known LED system

| Light Cycling in | | % photons | % photons | % photons |
|---|---|---|---|---|
| LED System | % photons | emitted | recycled | lost |
| 1^{st} pass | 100 | 35 | 55 | 10 |
| 2^{nd} pass | 55 | 19 | 30 | 6 |
| 3^{rd} pass | 30 | 11 | 17 | 3 |
| 4^{th} pass | 17 | 6 | 9 | 2 |
| 5^{th} pass | 9 | 3 | 5 | 1 |
| 6^{th} pass | 5 | 2 | 3 | 1 |
| 7^{th} pass | 3 | 1 | 2 | 0 |
| 8^{th} pass | 2 | 1 | 1 | 0 |

| | | |
|---|---|---|
| Total light | 78 | 22 |

As will be further described the above problems are addressed in some embodiments of the invention by utilizing a photoluminescence conversion component having an aspect ratio in an axial direction of greater than 1:1.5 and in which the phosphor surface area is at least three times the area of the LED package.

Air Interface Losses

As previously noted, one problem with existing LED-based lamps is the relatively poor emission efficiency. One reason this may occur in remote phosphor applications that utilize a hollow shell component having air within its central volume is that light must pass through three air/solid refractive index interfaces. Firstly photons pass from the LED package into the air in the cavity (interface 1). Secondly, photons pass into the remote phosphor (interface 2) and finally the photon exits the remote phosphor into air (interface 3). The number of passes through this interface is further increased by the mixing chamber effect of remote phosphor. Light that is emitted by the phosphor is just as likely to be re-emitted into the mixing chamber (internal volume of the component) than exit the component. This means many times photons are cycled through the mixing chamber multiple times. Each passage through an air/solid refractive index interface results in added losses (about 4% per interface pass). In contrast when a remote phosphor having a light transmissive plastic or silicone center is used the light goes directly from the LED through this clear high refractive index material to the remote phosphor since there is no longer an air/solid interface. Photons that travel back into the mixing chamber also do so without an interface. The result is less losses.

FIG. 7B shows an example configuration for a remote phosphor LED lamp that includes a dome-shaped (hemispherical) wavelength conversion component (optic) 38 and an array of LEDs 34. The interior volume 40 of the component 38 is filled with air, creating an air interface between the wavelength conversion component 38 and the array of LEDs 34.

In operation, LED light is produced by the array of LEDs 34, which is emitted towards the wavelength conversion component 38 to be absorbed by the phosphor 36 to further emit photoluminescence light. The photoluminescence light is emitted in all directions, including back within the interior volume 40 filled with air within the wavelength conversion component 38. In addition, LED light will be scattered by the wavelength conversion component 38 back through the interior volume 40 of the wavelength conversion component 38.

The problem is that there is a large mismatch between the index of refraction of the material of the wavelength conversion component 38 and the index of refraction of the air within the interior volume 40 of the wavelength conversion component. This mismatch in the indices of refraction for the interfaces between air and the lamp components causes a significant portion of the light to be lost in the form of heat generation. As a result for a given input power, less light is emitted from the lamp and increased heat generated. This inefficiency causes larger amounts of power to be used to produce a given amount of emitted light. This type of inefficiency also causes lamp designs to require large and bulky thermal management structures to handle the amount of heat produced by the LED lamp. In fact, the amount of thermal management structures that is typically required is so large as to proportionally dominate the volume of a conventional LED lamp. This effectively prevents most LED lamps from being able to possess physical dimensions that provide light emitting characteristics sufficient to satisfy requirements of various standardization and regulatory bodies.

As will be further described the above problems are addressed in some embodiments of the invention by utilizing a solid component instead of a hollow shell. The solid component allows the interior of the wavelength conversion component to comprise a material possessing an index of refraction that more closely matches the index of refraction for the wavelength conversion component and/or the LEDs. This permits light to be emitted to, within, and/or through the interior volume of the wavelength conversion component without having to incur losses caused by excessive mismatches in the indices of refraction for an air interface.

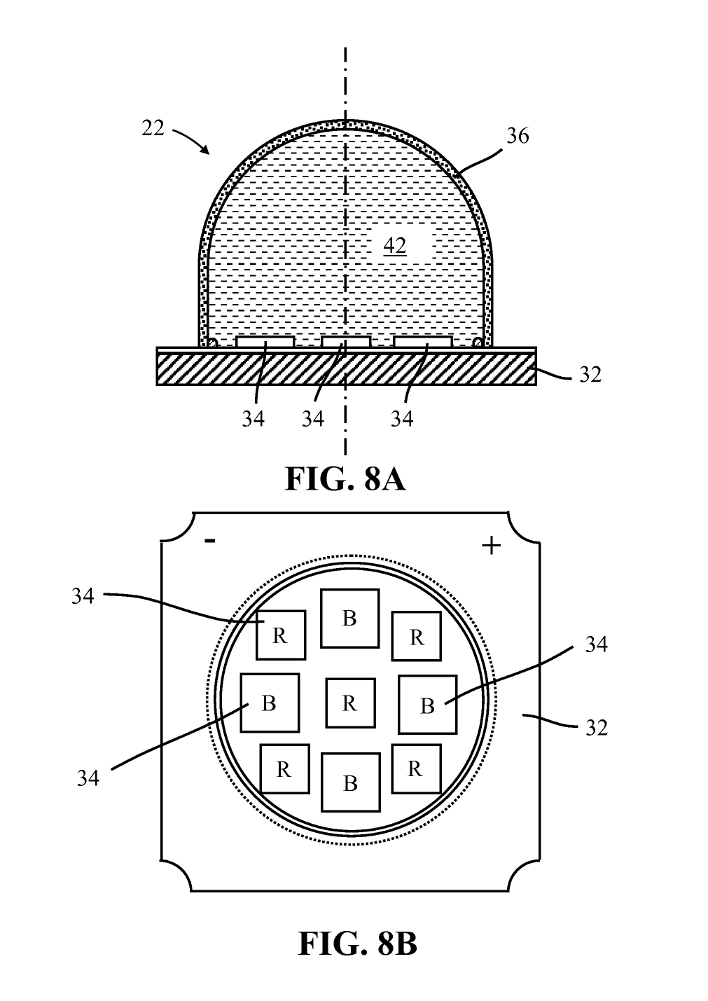

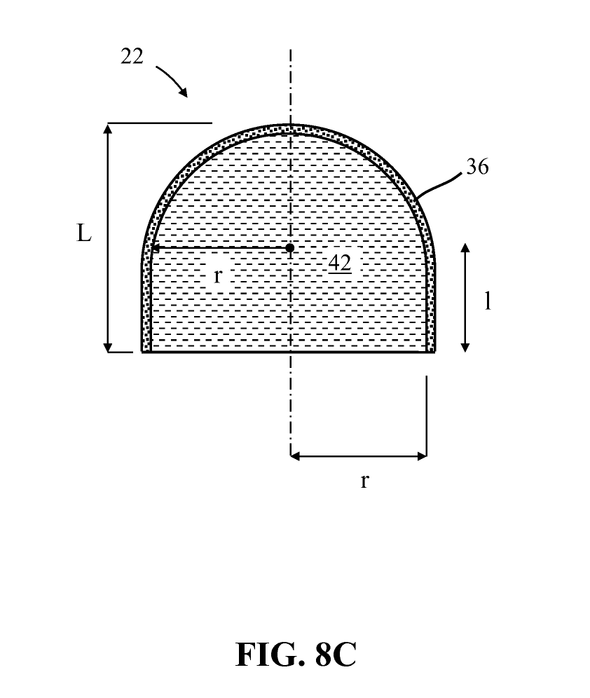

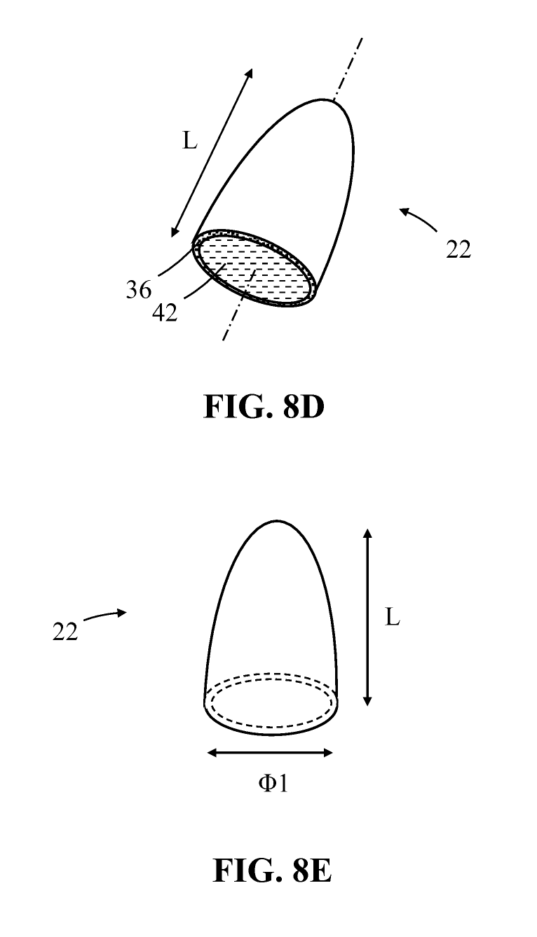

FIGS. 8A and 8B provide an illustration of an LED lamp according to an embodiment of this invention. The LED lamp includes a wavelength conversion component 22 and an array of LED chips 34, e.g. an array of red LED chips and blue LED chips. In this exemplary embodiment the interior volume of the wavelength conversion component 22 is not filled with air as in the earlier embodiments, but is instead filled with a light transmissive optical medium 42, which eliminates any air interface between the wavelength conversion component 22 and an array of LEDs 34. This facilitates light coupling for any light that traverses through the interior volume of the wavelength conversion component 22. The wavelength conversion component 22 thus comprises a solid component 42 having an exterior layer of photoluminescence material 36.

In some embodiments, the array of blue and red LED chips comprises generally two blue to one red or three blue to one red ratio. In the embodiment shown in FIG. 8B there are five red LED chips to four blue LED chips though the power of the blue LED chips is typically greater than those of the red LED chips. The use of red LEDs improves the quality of light emitted by the lamp and finds particular utility in applications requiring a high quality light emission such as applications with a CRI (Color Rendering Index) of 90 of higher. In some embodiments, only blue LED chips are used in the LED chip array 34.

The composition of the solid optical medium 42 is selected to possess an index of refraction that generally matches the index of refraction for the wavelength conversion component 22 and/or the LED chips 34. For example, the wavelength conversion component 22 may comprise a silicone or polymer base material having an index of refraction in the general range of 1.4-1.6. The encapsulant/potting material for many LED package components is often made of materials (such as silicone) having an index of refraction in a similar range of 1.4-1.6. The solid optical medium 42 may be selected of a material, e.g. silicone, to generally fall within or match this range. This high refractive index material in the LED package facilitates effective blue light extraction from the LED chip, e.g. increasing performance by 20% or more. The use of a silicone or similar polymer in the center of this shape that couples from the LED to the outer remote phosphor also serves for improving light extraction from the LED chip. This facilitates the use of the arrays of LED chips without requiring clear lenses or domes on each LED chip. Light extraction can be directly implemented in this embodiment of the invention, decreasing the cost of the LED chip packaging by integrating the light extraction and remote phosphor features into a single device.

In operation, LED light is produced by the array of LED chips 34, which is then emitted through the solid optical medium (component) 42 to the wavelength conversion layer 36 to further emit photoluminescence light. The photoluminescence light is emitted in all directions, including back within the interior volume filled with the solid optical medium 42 within the wavelength conversion component 22.

Since the refractive indices of the array of LED chips 34, the solid optical component 42, and the wavelength conversion layer 36 all generally match, this greatly reduces the amount of light that is lost due to the light coupling effects of the solid optical component 42. This permits the lamp to significantly increase the amount of light output for a given quantity of input power. This also means that much less heat is produced by the loss of the light.

Minimizing SQE Losses

By appropriately configuring the aspect ratio of the wavelength conversion component 22 it is possible to virtually eliminate the SQE losses described earlier. Preliminary tests indicate that by eliminating such losses, such a system can have an increase in total light emission of up to 20%. As described earlier the aspect ratio of the wavelength conversion component is the ratio of the size of the component opening to the length of the component. Where the component is solid, and hence technically does not have an opening, the relevant dimension is the optical opening or aperture of the component and corresponds to the size of LED array. Furthermore the area aspect ratio of the wavelength conversion component is defined as the area of the phosphor layer to the area of the LED package. FIG. 8C is an example of such a component that comprises a cylindrical body of axial length l and radius r having a hemispherical end and a planar end which is mountable to an LED package. The phosphor is provided on the cylindrical and hemispherical surfaces of the component. In this exemplary embodiment the area of LED package (i.e. the planar base of the component) is πr² whilst the surface area of the wavelength conversion component (phosphor) is 2πr²+2πrl. As a result the area aspect ratio is 2(r+l)/r:1. For a component in which the length l=0.5r, that is a component whose length in an axial direction is one and a half times its diameter, the area aspect ratio is 3:1. For such a component the solid optic 42 transmits the majority of light to the opposite side of the phosphor optic and very little light returns to the LED and package base. Travelling through the solid optical medium 42 has no refractive index changes so there is virtually 100% efficiency. Therefore the goal of this design is to maximize light emission by minimizing the amount of light returning to the LED package. Table 3 tabulates the losses from light cycling assuming a 90% efficient package and 60% light returning into LED package for a system based on the component of FIG. 5C with an area aspect ratio of 3:1. The result is a model that shows the potential for a 98% quantum efficient system.

TABLE 3
SQE losses for an LED system in accordance with the invention

| | | | photons | | |
|---|---|---|---|---|---|
| | | | emitted | | |
| Light | | photons | from | | % |
| Cycling in | photons | emitted | opposite | % photons | photons |
| LED System | (%) | (%) | wall (%) | recycled | lost |
| 1^{st} pass | 100 | 35 | 20 | 55 | 1.7 |
| 2^{nd} pass | 44 | 15 | 9 | 30 | 0.3 |
| 3^{rd} pass | 20 | 7 | 4 | 17 | 0.1 |
| 4^{th} pass | 9 | 3 | 2 | 9 | 0.1 |
| 5^{th} pass | 4 | 1 | 1 | 5 | 0 |
| 6^{th} pass | 2 | 1 | 0 | 3 | 0 |

| | | |
|---|---|---|
| Total light | 98 | 2 |

It is believed that to achieve a SQE of 98% requires a combination of number of factors; these being:

i) a coupling optic—An optical material having a high refractive index material coupled directly to LEDs and the phosphor conversion component. This material should have a refractive index of 1.4 or greater (≧1.5 preferred). Good optical coupling between the blue LEDs and the clear optic is required to ensure that it effectively acts as a light transport layer. By eliminating air interfaces and refractive index mismatches virtually all light generated by the LED chips will travel with virtually 0% loss to the wavelength conversion component (phosphor layer).

ii) phosphor wavelength conversion layer with an aspect ratio greater than 1:1—the phosphor layer is separated from the blue LEDs by the clear coupling optic. Ideally the outer phosphor optic is the same refractive index as the clear layer and has no gap or other optical loss in the interface to the clear optic. The Phosphor outer layer optic has an aspect ratio of 1:1 or greater such that the total surface area of the outer phosphor layer in contact with the clear coupling optic is more than three times the area of the LED package surface coupled to the clear coupling optic.

In operation blue light travels through the clear coupling optic with virtually 0% loss. When the blue light excites the phosphor layer and the photoluminescence light can now travel equally in any direction due to the elimination of the optical medium/air interface. Due to the high aspect ratio of the photoluminescence wavelength conversion component a majority of light (both phosphor generated light and scattered LED light) will not travel back to the LED package. Instead most light will travel through the 0% loss clear optic to the other side and exit out of the phosphor layer on the opposing side. Once converted, YGR (Yellow, Green, Red) light easily passes through the phosphor layer. In summary the majority of light is no longer recycled directly between the phosphor and the package/LEDs as it is in standard LED configurations.

The wavelength conversion component 22 may be formed of any suitable shape or configuration. FIGS. 8D and 8E illustrate an embodiment of a wavelength conversion component 22 having an elongated hem-ellipsoidal shape, e.g. a shape where the aspect ratio (i.e. ratio of diameter Φ1 to length L) is greater than 1, and is typically at least 1:1.5. As another example of a shape, the wavelength conversion component 22 may be substantially or generally cylindrical at its end closest to the array, and may be tapered to a point at its end furthest from the array. In certain applications, this ratio permits better light distribution properties for the LED lamps that employ such components. In particular, since the present invention can reduce heat generation, this means that the LED lamp can employ smaller thermal management structures for a given light output/power for the lamp. A more elongated structure for the wavelength conversion component, in combination with smaller heat sink sizes, permits better light distribution and emissions characteristics, e.g. for emissions in downwards directions in applications that use LED lamps as bulbs for a desk light.

LED Lamp and/or Photoluminescence Component Manufacture

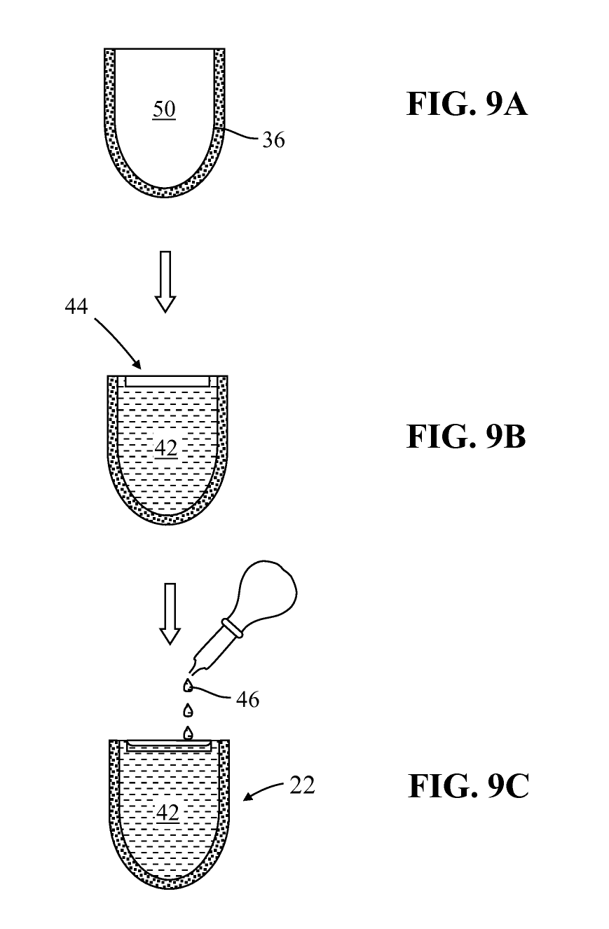

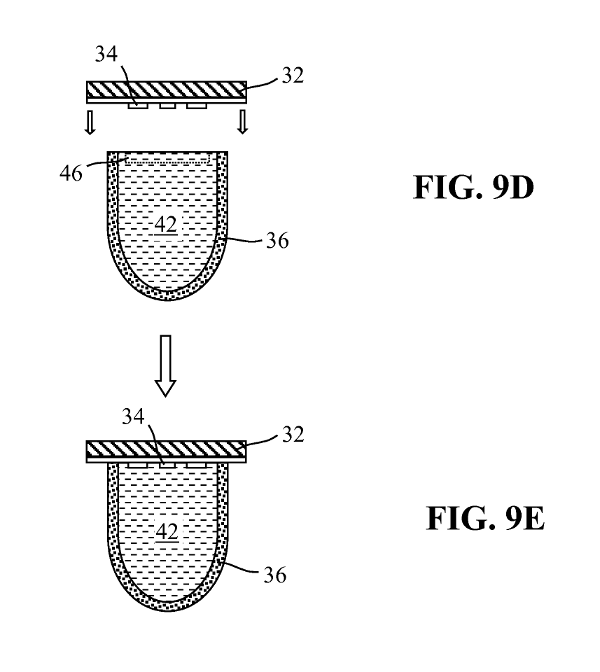

FIGS. 9A-9E illustrate an approach for manufacturing an LED lamp and/or LED lamp components according to some embodiments of the invention. FIG. 9A illustrates a high aspect ratio dome-like wavelength conversion component. To manufacture such components, phosphor material can be mixed with a light transmissive polymer, and the polymer/phosphor mixture extruded or injection molded to form the wavelength conversion component 22 with the phosphor material homogeneously distributed throughout the volume of the component. A heating process may be used to melt and mix the phosphor material with the polymer material, which is then cooled to form the final shape of the wavelength conversion component 22. Hot runners may be employed to ensure efficient usage of the constituent components for the molding process. Vacuum molding may also be employed to manufacture the three-dimensional wavelength conversion components.

FIG. 9B illustrates introduction of the solid optical component 42 into the interior volume 50 of the wavelength conversion component 22. The solid optical component 42 may be composed of an index matching gel or liquid material, which is poured into the interior volume formed by the inner surfaces of the wavelength conversion component 22. A curing process is then employed to cure the index matching gel or liquid material into its final solid form, e.g. by application of heat or UV light. An injection molding and/or co-extrusion process may also be used to introduce the solid optical component 42 into the interior volume of the wavelength conversion component 22. The solid optical component 42 may be formed to include an open portion or recess 44. The open portion 44 is sized to adequately fit over one or more LED chips. As another example, a solid optical component 42 may be separately fabricated, then attached to the wavelength conversion component 22 in any suitable manner, such as by interference fit, pressure fit, or adhesive.

As shown in FIG. 9C, the assembly is then prepared for attachment of the circuit board 32 containing the LED chips 34. The circuit board 32 containing the LED chips 34 in some embodiments comprises a COB array. Optionally, an index matching material 46 is poured into the open portion 44 in sufficient quantities to remove any air spaces when the circuit board 32 is attached. As shown in FIG. 9D, the circuit board is then attached to the assembly. The index matching material 46 is then cured into a solid to form the final product shown in FIG. 9E. The index matching material typically comprises the same material as the solid optical medium 42.

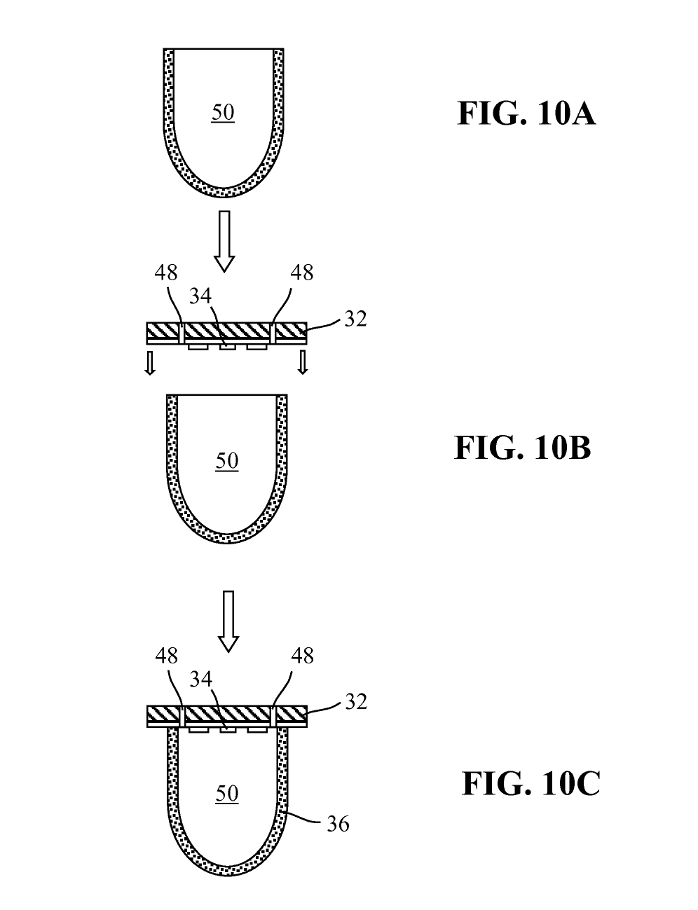

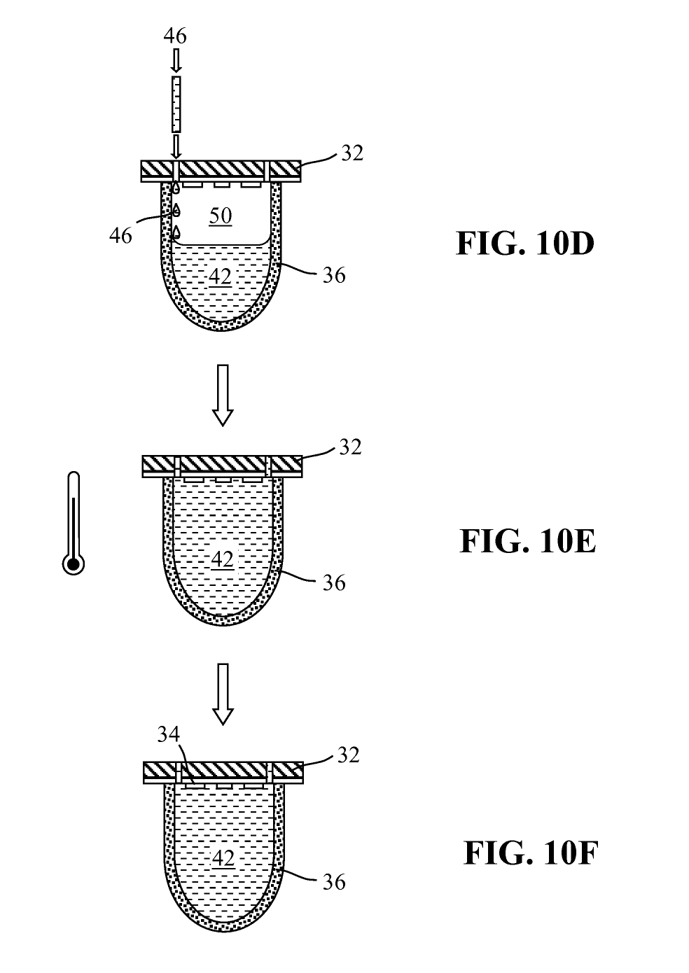

FIGS. 10A-10F illustrate an alternate approach for manufacturing an LED lamp and/or LED lamp components according to some embodiments of the invention. Similar to the above description, FIG. 10A illustrates that phosphor material can be mixed with a light transmissive polymer, and the polymer/phosphor mixture extruded or injection molded to form the wavelength conversion component 22 with the phosphor material homogeneously distributed throughout the volume of the component. A heating process may be used to melt and mix the phosphor material with the polymer material, which is then cooled to form the final shape of the wavelength conversion component 22. Hot runners may be employed to ensure efficient usage of the constituent components for the molding process. Vacuum molding may also be employed to manufacture the three-dimensional wavelength conversion components.

As shown in FIG. 10B, the circuit board 32 containing the LED chips 34 is attached to the wavelength conversion component 22. The circuit board 32 containing the LEDs 34 in some embodiments comprises a COB array. This forms the assembly shown in FIG. 10C.

One or more openings or ports 48 are provided for introducing the optical medium 42. The opening(s) 48 may be formed into any of the components of the assembly. For example, as shown the opening 48 may be formed in the circuit board 32. Alternatively, the opening(s) 48 may be formed in the wavelength conversion component 22.

As shown in FIG. 10D, the index matching material 42 is poured through the opening 48 into the interior volume 50. Enough of the index matching materiel 46 is added to remove any air spaces within the interior volume 50. The openings 48 can be sealed, as shown in FIG. 10E. As illustrated in FIG. 10F, the index matching material 46 is then cured into a solid to form the solid optical component 42.

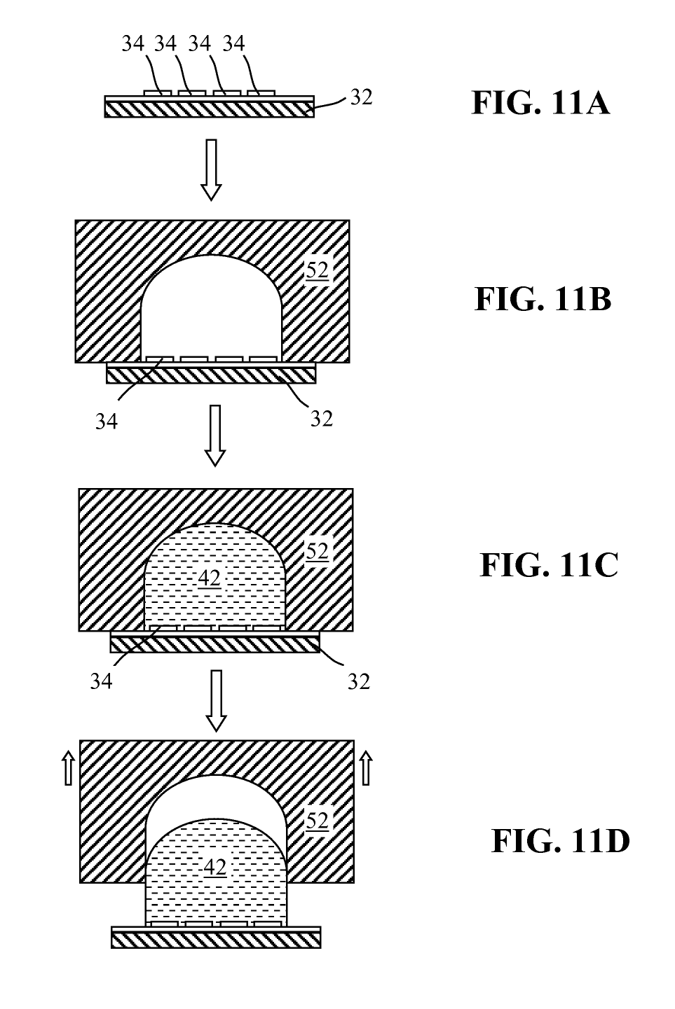

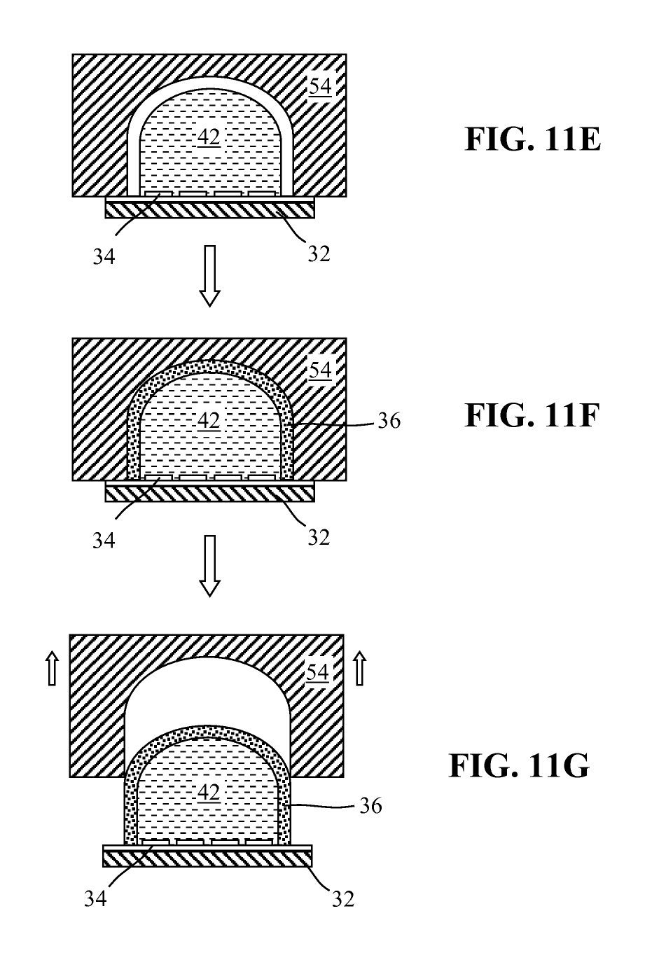

FIGS. 11A-11G illustrate another approach for manufacturing an LED lamp and/or LED lamp components according to some embodiments of the invention. As shown in FIG. 11A, the process starts with a circuit board 32 having the array of LED chips 34. As illustrated in FIG. 11B, a mold 52 is fitted to the circuit board 32 as part of a molding process (e.g. an injection molding process), which as shown in FIG. 11C is used to form the solid optical component 42 directly on the LED chips 42. FIG. 11D shows removal of the mold 52 from the circuit board 32.

At this point, the solid optical component 42 has been formed in a manner that completely envelopes the LED chips 34, removing any air gaps or interfaces that may otherwise exist between the LED chips and the solid optical component 42. The mold 52 is configured to exactly match the inner surface contours of the wavelength conversion component. Therefore, the exterior dimensions of the solid optical component 42 now match the expected inner surface profile of the wavelength conversion layer 36.

Next, as shown in FIG. 11E, a second mold 54 is fitted to the assembly to begin the process of forming the wavelength conversion layer 36. As illustrated in FIG. 11F, phosphor material mixed with a light transmissive polymer is injection molded using mold 54 to form the wavelength conversion component 22. The mold 54 is then removed as shown in FIG. 11G. It is noted that vacuum molding may also be employed to manufacture the components using molds 52 and/or 54.

Some embodiments of the invention comprise a diffuser layer having particles of a light diffusive material (also referred to herein as “light scattering material”). One benefit of this arrangement is that by selecting an appropriate particle size and concentration per unit area of the light diffractive material, it is possible to make a device having an emission product color that is virtually uniform with emission angle over a ±60° range from the emission axis. Moreover the use of a light scattering material can substantially reduce the quantity of phosphor material required to generate a selected color of emitted light. In addition, the light diffusing material can significantly improve the white appearance of the light emitting device in its “OFF” state.

In operation blue light (and/or red light) generated by the LEDs travels through the wavelength conversion component until it strikes a particle of phosphor material. It is believed that on average as little as 1 in 10,000 interactions of a photon with a phosphor material particle results in absorption and generation of photo luminescence light. The majority, about 99.9%, of interactions of photons with a phosphor particle result in scattering of the photon. Due to the isotropic nature of the scattering process on average half of the photons will scattered in a direction back towards the LEDs. For a cool white light emitting device the amount of phosphor material is selected to allow approximately 10% of the total incident blue light to be emitted from the wavelength conversion component and contribute to the emission product that is viewed by an observer. The majority, approximately 80%, of the incident light is absorbed by the phosphor material and re-emitted as photo luminescence light. Due to the isotropic nature of photo luminescence light generation, approximately half of the light generated by the phosphor material will be emitted in a direction towards the LED.

One problem associated with LED lighting device that is addressed by embodiments of the invention is the non-white color appearance of the device in an “OFF” state. During an “ON” state, the LED chip or die generates blue light and some portion of the blue light is thereafter absorbed by the phosphor(s) to re-emit yellow light (or a combination of green and red light, green and yellow light, green and orange or yellow and red light). The portion of the blue light generated by the LED that is not absorbed by the phosphor combined with the light emitted by the phosphor provides light which appears to the human eye as being nearly white in color.

However, in an OFF state, the LED chip or die does not generate any blue light. Instead, light that is produced by the remote phosphor lighting apparatus is based at least in part upon external light (e.g. sunlight or room lights) that excites the phosphor material in the wavelength conversion component, and which therefore generates a yellowish, yellow-orange or orange color in the photoluminescence light. Since the LED chip is not generating any blue light, this means that there will not be any residual blue light to combine with the yellow/orange light from the photoluminescence light of the wavelength conversion component to generate white appearing light. As a result, the lighting device will appear to be yellowish, yellow-orange or orange in color. This may be undesirable to the potential purchaser or customer that is seeking a white-appearing light.

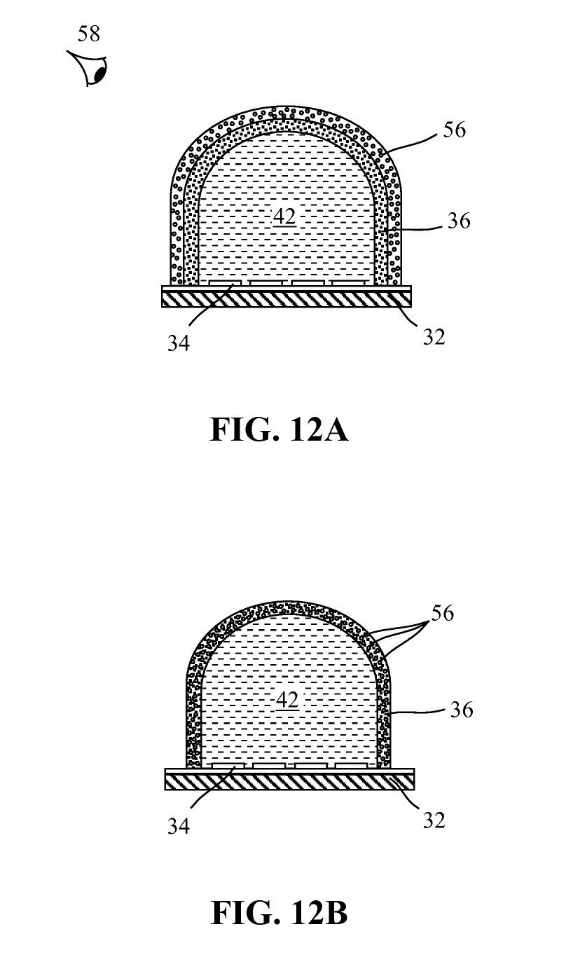

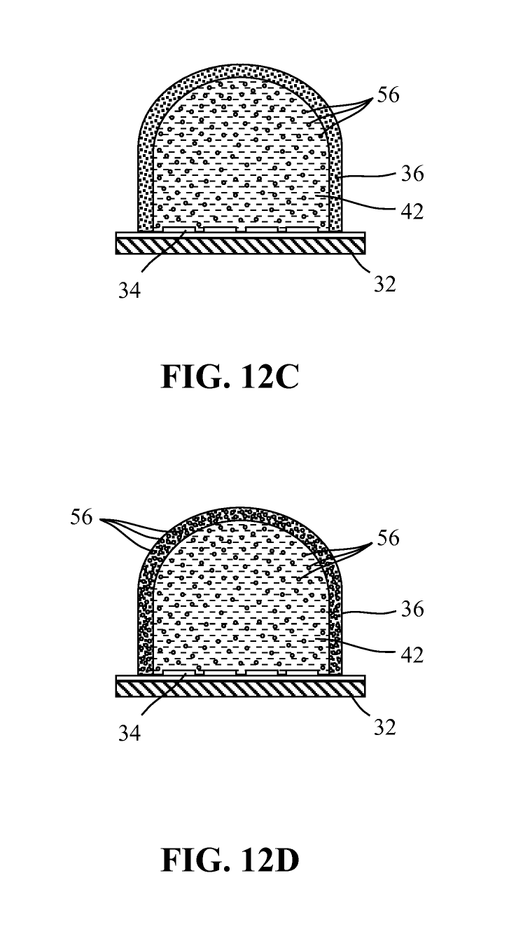

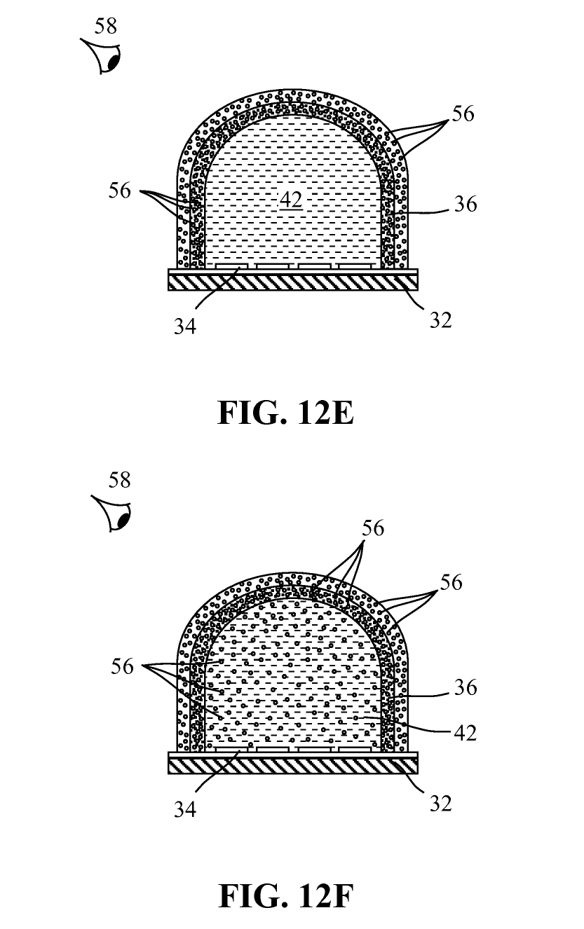

According to the embodiment of FIG. 12A, a layer of light diffusing material 56 provides the benefit of addressing this problem by improving the visual appearance of the device in an OFF state to an observer 58. In part, this is because the light diffusing layer includes particles of a light diffractive material 56 that can substantially reduce the passage of external excitation light that would otherwise cause the wavelength conversion component to re-emit light of a wavelength having a yellowish/orange color.

The particles of a light diffractive material in the light diffusing layer 56 are selected, for example, to have a size range that increases its probability of scattering blue light, which means that less of the external blue light passes through the light diffusing layer to excite the wavelength conversion layer. Therefore, the remote phosphor lighting apparatus will have more of a white appearance in an OFF state since the wavelength conversion component is emitting less yellow/red light.

The light diffractive particle size can be selected such that the particles will scatter blue light relatively more (e.g. at least twice as much) as they will scatter light generated by the phosphor material. Such a light diffusing layer ensures that during an OFF state, a higher proportion of the external blue light received by the device will be scattered and directed by the light diffractive material away from the wavelength conversion layer, decreasing the probability of externally originated photons interacting with a phosphor material particle and minimizing the generation of the yellowish/orange photoluminescent light. However, during an ON state, phosphor generated light caused by excitation light from the LED light source can nevertheless pass through the diffusing layer with a lower probability of being scattered. Preferably, to enhance the white appearance of the lighting device in an OFF state, the light diffractive material within the light diffusing layer is a “nano-particle” having an average particle size of less than about 150 nm. For light sources that emit lights having other colors, the nano-particle may correspond to other average sizes. For example, the light diffractive material within the light diffusing layer for an UV light source may have an average particle size of less than about 100 nm.

Therefore, by appropriate selection of the average particle size of the light scattering material, it is possible to configure the light diffusing layer such that it scatters excitation light (e.g. blue light) more readily than other colors, namely green and red as emitted by the photoluminescence materials. For example, TiO₂ particles with an average particle size of 100 nm to 150 nm are more than twice as likely to scatter blue light (450 nm to 480 nm) than they will scatter green light (510 nm to 550 nm) or red light (630 nm to 740 nm). As another example, TiO₂ particles with an average particle size of 100 nm will scatter blue light nearly three times (2.9=0.97/0.33) more than it will scatter green or red light. For TiO₂ particles with an average particle size of 200 nm these will scatter blue light over twice (2.3=1.6/0.7) as much as they will scatter green or red light. In accordance with some embodiments of the invention, the light diffractive particle size is preferably selected such that the particles will scatter blue light relatively at least twice as much as light generated by the phosphor material(s). Another problem with remote phosphor devices that can be addressed by embodiments of the invention is the variation in color of emitted light with emission angle. This problem is commonly called COA (Color Over Angle). Improved Color Over Angle—Remote phosphor layers allow a certain amount of blue light to escape as the blue component of white light. This is directional light coming from the LEDs. The RGY (Red Green Yellow) light coming from the phosphor is lambertian. Therefore the directionality of the blue light may be different than that of the RGY light causing a “halo” effect at the edges with color looking “cooler” in the direction of the blue LED light and “warmer” at the edges where the light is all RGY. The addition of nano-diffuser selectively diffuses blue light—causing it to have the same lambertian pattern as the RGY light and creating a very uniform color over angle. Traditional LEDs also have this problem which can be improved by remote phosphor using this technology.

Improved Red Blue systems—some LED systems are using red and blue LEDs. The native red LEDs are a very efficient source of red light and eliminate the need for costly red phosphor. However, blending red and blue light with phosphor light and also avoiding loss of the red light during pass though is critical. Remote phosphor with nano-diffuser selectively scatters blue, allows red to pass through without high loss and provides a very effective mixing of the light to avoid color over angle and other color separation effects.

In particular, remote phosphor devices are often subject to perceptible non-uniformity in color when viewed from different angles. Embodiments of the invention correct for this problem, since the addition of a light diffusing layer in direct contact with the wavelength conversion layer significantly increases the uniformity of color of emitted light with emission angle θ.

Embodiments of the present invention can be used to reduce the amount of phosphor materials that is required to manufacture an LED lighting product, thereby reducing the cost of manufacturing such products given the relatively costly nature of the phosphor materials. In particular, the addition of a light diffusing layer composed of particles of a light diffractive material can substantially reduce the quantity of phosphor material required to generate a selected color of emitted light. This means that relatively less phosphor is required to manufacture a wavelength conversion component as compared to comparable prior art approaches. As a result, it will be much less costly to manufacture lighting apparatuses that employ such wavelength conversion components, particularly for remote phosphor lighting devices.

In operation, the diffusing layer increases the probability that a photon will result in the generation of photoluminescence light by reflecting light back into the wavelength conversion layer. Therefore, inclusion of a diffusing layer with the wavelength conversion layer can reduce the quantity of phosphor material required to generate a given color emission product, e.g. by up to 40%. FIGS. 12A-12F illustrate different approaches to introduce light scattering materials into an LED lamp, which can substantially reduce the quantity of phosphor material required to generate a selected color of emitted light. In addition, the light diffusing layer can be used in combination with additional scattering (or reflective/diffractive) particles in the wavelength conversion component to further reduce the amount of phosphor material that is required to generate a selected color of emitted light.

As described in FIG. 12A the light scattering material 56 is included within a separate layer on the outside of the wavelength conversion component. FIG. 12B illustrates an approach in which the light scattering material 56 is included within the wavelength conversion layer 36. FIG. 12C illustrates an alternative approach in which the light scattering material 56 is dispersed within the solid optical component 42. FIG. 12D illustrates an approach in which the light scattering material 56 is introduced into both the wavelength conversion layer 36 and the solid optical component 42. FIG. 12E illustrates an approach in which the light scattering material 56 is included within both a separate layer on the outer surface of the wavelength conversion layer and the wavelength conversion layer 36. FIG. 10F illustrates an approach in which the light scattering material 56 is included within each of the separate outer layer, the wavelength conversion layer 36, and the solid optical component 42.

It will be appreciated that the present invention is not restricted to the specific embodiments described and that variations can be made that are within the scope of the invention.

What is claimed:

1. A solid-state lamp comprising:
an array of solid-state excitation sources;
a photoluminescence wavelength conversion component comprising a layer of photoluminescence material and a coupling optic,
wherein the layer of photoluminescence material is remote to the excitation sources and wherein the coupling optic is disposed between the excitation sources and the layer of photoluminescence material; and
wherein a ratio of the photoluminescence material surface area of the layer of the photoluminescence material to the excitation source surface area for the array of solid-state excitation sources is at least 3 to 1.

2. The lamp of claim 1, wherein the layer of the photoluminescence material has an aspect ratio selected from the group consisting of: greater than 1 to 1, greater than 1 to 1.5, greater than 1 to 2, and greater than 1 to 3.

3. The lamp of claim 1, wherein the coupling optic is a solid light transmissive material.

4. The lamp of claim 1, wherein the coupling optic comprises a material having a refractive index material that substantially matches the refractive index of the layer of the photoluminescence material.

5. The lamp of claim 1, wherein the layer of the photoluminescence material comprises at least a portion that comprises a substantially hemispherical shell.

6. The lamp of claim 1, wherein the layer of the photoluminescence material comprises a substantially hemi-ellipsoidal shell.

7. The lamp of claim 1, and further comprising a layer of a light diffusive material on the exterior surface of the photoluminescence component.

8. The lamp of claim 1, and further comprising a light diffusive material incorporated into the layer of the photoluminescence material.

9. The lamp of claim 1, and further comprising a light diffusive material incorporated into the coupling optic.

10. A photoluminescence component comprising: a light transmissive hollow component defining an interior volume and having a substantially circular cross section, a substantially circular opening and at least one photoluminescence material which generates light in response to excitation light, wherein the ratio of the opening diameter to length of the component in an axial direction is at least 1 to 1.5.

11. The component of claim 10, wherein the ratio of the opening diameter to the length of the component is at least 1 to 3.

12. The component of claim 10, wherein the length of the component and a maximum internal diameter are substantially equal.

13. The component of claim 10, wherein the component comprises at least a portion comprising a substantially hemispherical shell.

14. The component of claim 10, wherein the component comprises a substantially hemi-ellipsoidal shell.

15. The component of claim 10, and further comprising a layer of a light diffusive material on the exterior surface of the component.

16. The component of claim 10, and further comprising a light diffusive material incorporated into the layer of the photoluminescence material.

17. A photoluminescence component comprising: a light transmissive hollow component defining an interior volume and having a substantially circular cross section, a substantially circular opening and at least one photoluminescence material which generates light in response to excitation light, wherein the ratio of the opening diameter to maximum internal diameter is in a range 1 to 1.25 and 1 to 2.5.

18. The component of claim 17, wherein the opening diameter to the length of the component in an axial direction is at least 1 to 3.

19. A photoluminescence component comprising: a light transmissive hollow component defining an interior volume and having an opening that is smaller than a maximum internal dimension of the component, wherein the component comprises a photoluminescence material which generates light in response to excitation light and wherein in operation when excited by excitation light from an excitation source located at or near said opening the component emits light over angles of at least 0° to ±135° with a variation in emission luminous intensity of less than about 20%.
